(19) United States
(12) Patent Application Publication
(10) Pub. No.: US 2016/0153576 A1
(43) Pub. Date: Jun. 2, 2016

(54) SOLENOID VALVE

(71) Applicant: DANFOSS A/S, Nordborg (DK)

(72) Inventors: Ole Mortensen, Kolding (DK); Michael Birkelund, Middelfart (DK); Ole Holst Christensen, Kolding (DK); Kristjan Arnor Gretarsson, Kolding (DK); Anders Pedersen, Middelfart (DK)

(73) Assignee: DANFOSS A/S, Nordborg (DK)

(21) Appl. No.: 14/900,669

(22) PCT Filed: Jun. 26, 2014
(86) PCT No.: PCT/IB2014/062608

§ 371 Date: Dec. 22, 2015

(30) Foreign Application Priority Data
Jun. 26, 2013 (EP) 13173878.3

(51) Int. Cl. F16K 31/06

(52) U.S. Cl. CPC F16K 31/06

(57) ABSTRACT

The invention relates to a solenoid valve with a housing as well as an inlet and an outlet, wherein the solenoid valve further comprises a valve element and an orifice, wherein the orifice comprises an orifice inlet and an orifice outlet. In order to increase the maximum operating pressure differential of the solenoid valve the orifice is provided in a membrane and the orifice has a diffuser characteristic in a direction from the orifice inlet to the orifice outlet.

### CROSS-REFERENCE TO RELATED APPLICATIONS

This application is entitled to the benefit of and incorporates by reference subject matter disclosed in the International Patent Application No. PCT/IB2014/062608 filed on Jun. 26, 2014 and European Patent Application No. 13173878 filed on Jun. 26, 2013.

### TECHNICAL FIELD

The invention relates to a solenoid valve comprising a housing having an inlet and an outlet, wherein the solenoid valve further comprises a valve element and an orifice, wherein the orifice comprises an orifice inlet and an orifice outlet and the orifice is provided in a membrane, and wherein the orifice has a diffuser characteristic in a direction form the orifice inlet to the orifice outlet.

### BACKGROUND

Solenoid valves are a known type of electronically operated valves. Solenoid valves are often used to control the flow of fluids or gases. Solenoid valves are either constructed as normally open or normally closed, depending on the preferred valve position. A solenoid valve is operated by opening or closing an orifice in a valve housing to permit or prevent the flow of a fluid or a gas through the valve. A magnetic coil is provided with electrical energy to move a slideable valve member interacting directly or indirectly with the valve element to open or close the valve.

In a normally closed valve, the valve element is often maintained against the valve seat by a return spring, preventing flow through the solenoid valve when electric current is not provided to the solenoid valve.

A solenoid valve of the above mentioned type is for example known from US 2005/0126218 A1. A shut-off valve for an expansion valve in refrigerating systems is disclosed. A slideable valve member is forced by a spring towards a closing position of the solenoid valve. The expansion valve furthermore comprises a pressure regulating valve with an orifice plate. Different types of possible orifices for the orifice plate are disclosed to adjust the flow characteristics from the inlet to the outlet.

A solenoid valve of the above mentioned type is also known from U.S. Pat. No. 6,076,550. Said document relates to a solenoid and a solenoid valve. A diaphragm valve comprises a valve box. The valve box has a flow-in path and a flow-out path. A main valve hole is formed between the flow-in path and the flow-out path; a diaphragm serves as a main valve for opening and closing the main valve hole. A diaphragm pressure chamber communicates with the flow-out path via a pilot valve hole. Said pilot valve hole is located at one and of a rectifying cone.

Solenoid valves of the above mentioned type have the problem of only being operated reliably when a maximum pressure difference between the inlet and the outlet pressures of the valve is not exceeded. Directly operated solenoid valves must often have a large maximum operating pressure differential of the solenoid valve to allow for a broad range of uses for the valve.

For directly operated solenoid valves, the main orifice is the only flow path through the valve. Directly operated solenoid valves are used in systems where either low flow capacities are sufficient or if the maximum operating pressure differential between the inlet and the outlet pressures of the valve are low. If the pressure differential between the inlet and the outlet is too large, directly operated solenoid valves cannot be operated reliably. The pressure acting on the valve member or the valve element may become too large to allow a controlled opening or closing of the solenoid valve, resulting in the valve element either not being displaced or displacement of the valve element requiring much force and possibly resulting in damage to the valve.

Problems mentioned above are less severe with piloted solenoid valves, wherein the solenoid valve allows or prevents fluid connections between different chambers of the valve. The main flow connection between inlet and outlet is only opened, if a minimum operating pressure differential between the inlet and the outlet is present, even if the solenoid valve is open.

### SUMMARY

The task of the present invention is to provide a solenoid valve with a large maximum operating pressure differential between inlet and outlet pressures of the valve.

According to the invention, the above mentioned task is solved in that the orifice comprises at least one conical orifice section wherein walls of the conical section are inclined relative to a central axis of the orifice by an angle of less than 10°.

Using an orifice with a diffuser characteristic allows to maintain a high pressure difference between the orifice inlet and the orifice outlet. The maximum operating pressure differential between the inlet pressure and the outlet pressure of the solenoid valve may be increased as compared to the state of the art. The orifice is furthermore provided in a membrane, and the higher pressure difference between the orifice inlet and the orifice outlet results in an increased pressure difference on both sides of the membrane. An increased pressure difference on both sides of the membrane may be used to change the opening operation of the valve. In particular, changing the opening operation of the valve will ensure that at least a minimum pressure difference between both sides of the membrane is present at all times. A minimum operating pressure differential necessary for a controlled opening and closing of the valve may also be maintained more easily. The orifice comprises at least one conical orifice section resulting in the orifice having a diffuser characteristic in a flow direction from an orifice inlet to an orifice outlet. At the same time, a high fluid flow through the orifice is achieved by increasing the flow speed as compared to an orifice with a substantially cylindrical shape. The conical orifice section preferably extends over most of the length L of the orifice. Preferably, the walls of the conical orifice section are inclined relative to a central axis of the orifice by an angle of less than 10°.

In yet another preferred embodiment, the walls of the conical orifice section are inclined relative to the central axis of the orifice by an angle of more than 2.5°. Hence, the walls of the conical orifice section may comprise an angle between 2.5° and 10° relative to the central axis of the orifice.

In a preferred embodiment, the cross-sectional area of the orifice inlet is smaller than the cross-sectional area of the orifice outlet resulting in the orifice having a diffuser characteristic. The pressure on the inlet side of the orifice inlet remains higher than the pressure on the outlet side of the orifice outlet.

In another preferred embodiment, the orifice comprises at least one cylindrical orifice section stabilizing the fluid flow and ensuring that the flow speed through the orifice is not reduced too much. The diffuser characteristic of the orifice will mostly be provided by the remaining sections of the orifice.

In yet another preferred embodiment the orifice is provided in an orifice member. Arranging the orifice in an orifice member allows to connect the orifice to the membrane and gives the possibility to choose shaping for the orifice to achieve the intended diffuser characteristic. Furthermore the orifice may then move together with the membrane.

In a preferred embodiment the orifice is an integral part of the membrane. Arranging the orifice as an integral part of the membrane allows to exclude an orifice member.

In another preferred embodiment the solenoid valve comprises at least one progressive spring, wherein the valve element is forced by the at least one progressive spring. By using a progressive spring, using several springs provided in individual bores is excluded. A progressive spring may be guided within a cylindrical bore of the solenoid valve to simplify assembly of the valve. The solenoid valve can be used at higher maximum operating pressure differentials, because the spring force of the progressive spring may be low upon opening the solenoid valve and may increase when the valve member has been displaced in the fully open position and the progressive spring is compressed by a large distance. The force of the spring forcing the valve element and the valve member towards the closed position, when the coil of the solenoid valve is not provided with electric current, can still be chosen large allowing to close the valve even in case of large fluid pressures. At the same time the progressive spring provides a spring force in the open position of the solenoid valve large enough to overcome adhesion forces and forces caused by residual magnetization. If the spring force is not large enough, the valve member is prevented from closing the valve.

In a preferred embodiment, the progressive spring comprises at least two spring sections, wherein at least two of the spring sections have a different pitch. The distance between individual turns of the spring sections is different in the at least two spring sections. Furthermore, the amount of compression of the progressive spring necessary can be adjusted until the spring section with the lower pitch is fully compressed, so that the spring section with the lower pitch becomes stiff. When the spring section with the lower pitch becomes stiff , the spring constant of the progressive spring is increased, because only the remaining spring section with a larger pitch may still be compressed. Preferably, the progressive spring comprises on at least one end a spring section with compressed windings. Thereby, the progressive spring is stabilized and may exert force evenly on the member against which it abuts, as example an anchor core and/or the valve member. Alternatively, the progressive spring may have only one spring section with a variable pitch.

In a further preferred embodiment, the spring section with the lower pitch is fully compressed in the open position of the solenoid valve. The force of the progressive spring acting on the valve element may be low in the closed position of the valve, while still retaining a large force of the progressive spring on the valve element in the open position of the valve element. The progressive spring may still displace the valve element towards the closed position even against large adhesion forces and/or forces caused by residual magnetization. At the same time, the force of the progressive spring forcing the valve element onto the valve seat in the closed position will not be large.

In another preferred embodiment, the solenoid valve is a normally closed valve, wherein the valve element sealingly abuts the valve seat, when the coil of the solenoid valve is not provided with an electrical current. The solenoid valve is normally closed with the progressive spring forcing the valve element towards the valve seat when the coil of the solenoid valve is not provided with electric current.

In a further preferred embodiment, the solenoid valve comprises a substantially cylindrical valve member received slideably within the solenoid valve. Substantially cylindrical means, that the radial outer circumference of the valve member is circular over most of the length of the valve member. The valve member is preferably magnetizable and may be displaced by activating a magnetic coil to allow the opening of the valve. The valve member will interact with the valve element to displace the valve element from the valve seat towards an opening direction.

In another preferred embodiment, the progressive spring is guided in a cylindrical bore, and the cylindrical bore is provided in the valve member. Assembly of the solenoid valve is simplified. Cylindrical bore means that the bore has a constant diameter over most of length of the bore. Furthermore, the valve element may be received inside the valve member. The valve member may interact with the valve element during opening or closing the solenoid valve.

In another preferred embodiment, the solenoid valve further comprises an aperture, and the valve element is slidably received in the aperture. This aperture is preferably provided inside the valve member at an end of the valve member towards the valve seat. Furthermore a washer may be provided in the aperture abutting the valve element. The washer may be used to keep pressure on the valve element to prevent the valve element from tilting. Tilting of the valve element is a problem, if the valve element has a small height. For example, the washer may be forced towards the valve element by a support spring. Using a washer also allows a wider range of elastic materials for the valve element without the danger of the valve element being damaged by the interaction with the progressive spring. For example the valve element may consist of polytetrafluorethylene.

In a further preferred embodiment, a protrusion extends from a radially inner circumference of the aperture, and the protrusion comprises an annular ledge at the end of the aperture towards the valve seat, and the annular ledge provides a stop for the valve element. Preferably, the protrusion results in a smaller opening of the aperture than the maximum radial extension of the valve element to prevent the valve element from exiting the valve member at the end of the valve member towards the valve seat. The protrusion provides a stop for the valve element for maintaining the valve element inside the valve member when the valve element is displaced in a direction away from the valve seat. Furthermore, the protrusion allows the valve member to engage the valve element upon opening the solenoid valve. The valve element preferably comprises an annular shoulder that substantially matches the shape of the annular ledge of the valve member.

Preferably, the valve member is first displaced in a direction away from the valve seat by a stroke distance, when the coil of the solenoid valve is provided with electric current. The valve member may first be displaced a first stroke distance and gain momentum when the coil of the solenoid valve is provided with electric current before the opening of the valve starts. A first stroke distance may be obtained by displacing the valve member an additional distance compared to displacement of the valve element after the valve element has already engaged the valve seat. Preferably the stroke distance is longer than 3 mm.

Preferably, the valve member engages the valve element and displaces the valve element from the valve seat, when the valve member has been displaced the first stroke distance. The valve member already has gained momentum by being accelerated through the magnetic field over the first stroke distance. Because the progressive spring has a lower spring constant at the point of opening, the valve member is not exerting a large force on the valve element when displacing the valve element from the valve seat against the force of the progressive spring.

In another preferred embodiment, the solenoid valve comprises an anchor core. The progressive spring is abutting the anchor core. The progressive spring preferably abuts the anchor core with a spring section comprising always compressed windings. The individual windings of the spring in spring section comprising always compressed windings abut against the neighboring windings. The spring is stabilized, especially in the open position of the solenoid valve. The anchor core may furthermore be connected to a substantially cylindrical casing. The casing may also enclose the valve member and the progressive spring and the valve element. The casing may be part of the housing or be connected to the housing. The anchor core and the casing may be part of an anchor of the solenoid valve.

In another preferred embodiment, an additional end bore is provided at the end of the valve member away from the valve seat, and the additional end bore has a larger cross-sectional area than the cylindrical bore. An additional end bore simplifies insertion of different parts of the solenoid valve, for example, the progressive spring. Furthermore, the additional end bore allows controlled resting of the valve element against an anchor core.

In another preferred embodiment, the anchor core comprises an anchor protrusion abutting the additional end bore when the valve element is displaced away from the valve seat. The anchor protrusion and the additional end bore may interact to define a controlled resting position of the valve member in the opened position of the solenoid valve. Furthermore, the anchor protrusion and the additional bore may prevent the progressive spring from being compressed too much. The progressive spring being compressed too much may result in a large force of the progressive spring acting on the valve element when the coil of the solenoid valve is not provided with electric current.

In another preferred embodiment the orifice member is connected to the membrane. Connecting the orifice member to the membrane results in the orifice member being displaced together with the membrane when opening or closing the valve.

In a further preferred embodiment the membrane is plane. The membrane will be more flexible than, for example, a membrane supported by weaves. To obtain a controlled displacement of the membrane a support structure for the membrane may be provided.

In another preferred embodiment the membrane is connected to a support structure. A flexible membrane can be used and the support structure still results in a controlled displacement of the membrane and the orifice. Furthermore, the surface of the membrane exposed to the pressures in the different chambers of the solenoid valve may be adjusted, as example an inlet chamber, an outlet chamber and a servo chamber.

Preferably, the support structure comprises at least one support member connected to the orifice member. A support structure comprising at least one support member connected to the orifice member results in the orifice member displacing together with the membrane and the membrane securely connected to the orifice member.

In another preferred embodiment the support structure comprises at least one support member comprising a plurality of openings. A support member comprising a plurality of openings may preferably be next to an inlet chamber of the solenoid valve. A large area of the membrane is exposed to the high pressure from the inlet side. The support member may also be used to attach the membrane to the housing for example at a radial outer end of the membrane.

The invention also relates to a vapor compression system comprising a solenoid valve according to any of the aforementioned embodiments.

### BRIEF DESCRIPTION OF THE DRAWINGS

A preferred embodiment of the invention will in the following be described with reference to the figures, wherein:

FIG. 1 shows a first cut view of a preferred embodiment of a solenoid valve according to the invention,

FIG. 2 shows a second cut view of a preferred embodiment of the solenoid valve,

FIG. 3 shows a cut view of the orifice according to a preferred embodiment of the solenoid valve, and

FIG. 4 shows a cut view of the progressive spring according to the invention.

### DETAILED DESCRIPTION

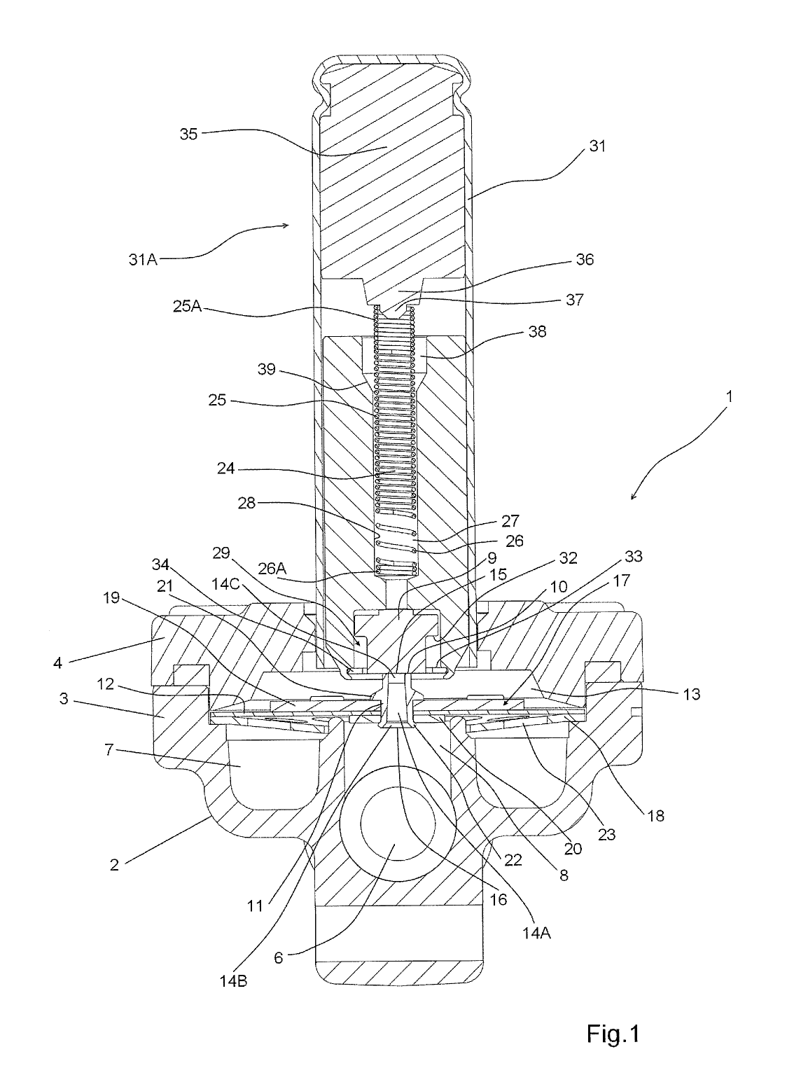

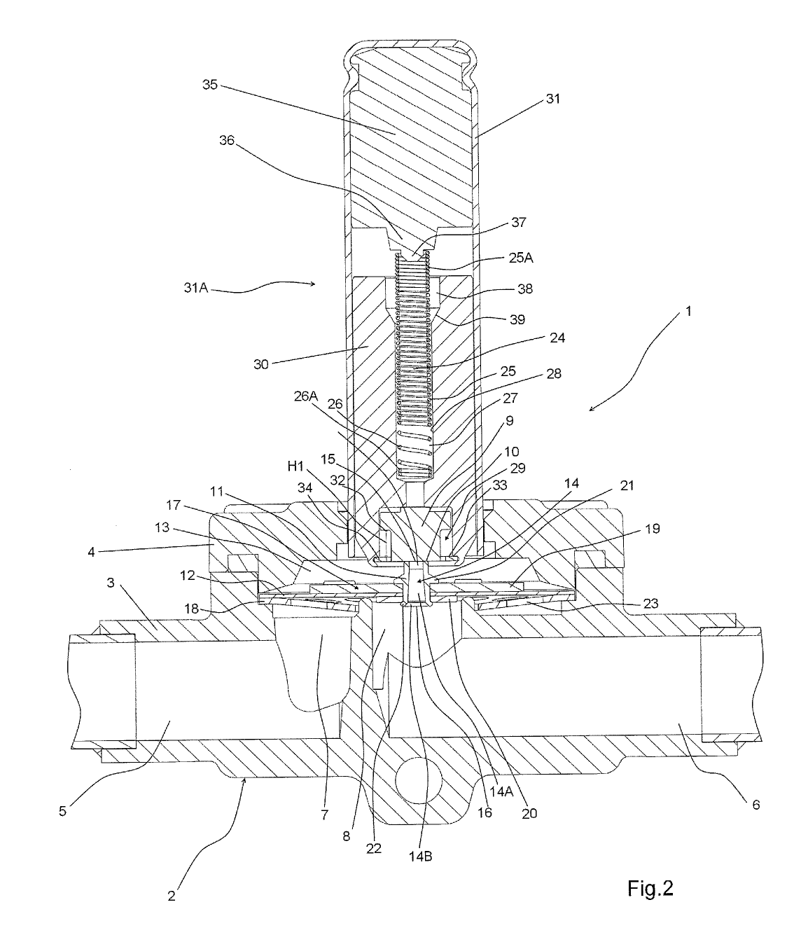

FIGS. 1 and 2 show a preferred embodiment of the solenoid valve 1. The figures show cut views rotated by 90° relative to each other. The solenoid valve 1 comprises a housing 2 with two housing sections 3, 4.

The solenoid valve 1 furthermore comprises an inlet 5 and an outlet 6. From the cut view of to FIG. 1 the inlet 5 is provided at the backside of the solenoid valve 1 and is thus not visible. The magnetic coil of the solenoid valve 1 is not shown for simplicity. In direct fluid connection to the inlet 5 an inlet chamber 7 is provided. An outlet chamber 8 is located in direct fluid contact with the outlet 6.

The solenoid valve is shown in the closed position of the valve, wherein a valve element 9 sealingly abuts the valve seat 10. The valve element 9 is preferably made from polytetrafluorethylene and comprises at least two cylindrical sections. The valve seat 10 is part of an orifice member 11. The orifice member 11 is connected to a membrane 12 separating the inlet chamber 7 from a servo chamber 13.

Within the orifice member 11 an orifice 14 is provided allowing a fluid connection between the outlet chamber 8 and the servo chamber 13 in the opened position of the solenoid valve 1.

Alternatively, an orifice member 11 may be excluded and the valve seat 10 and the orifice 14 may be constructed as integral parts of the membrane 12. The membrane may be made from polytetrafluorethylene.

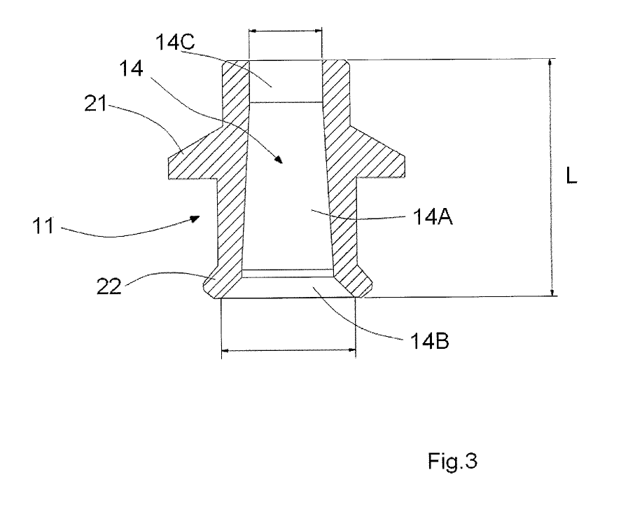

A detailed view of the orifice 14 is shown in FIG. 3. The orifice 14 comprises a conical orifice section 14A and has a diffuser characteristic in a flow direction from an orifice inlet 15 to an orifice outlet 16. The conical orifice section 14A preferably extends over most of the length of the orifice L. Preferably, the walls of the conical orifice section 14A are inclined relative to a central axis of the orifice 14 by an angle of less than 10°. The orifice 14 may also comprise a conical outlet section 14B. The orifice 14 may furthermore comprise a cylindrical orifice section 14C. In particular the orifice inlet 15 has a smaller cross-sectional area than the orifice outlet 16.

The conical orifice section 14A improves the diffuser characteristic and the fluid flow speed through the orifice 14. The orifice 14 has a flow capacity comparable to cylindrical orifices with a larger inlet area used in the state of the art, but the orifice 14 decreases the pressure drop over the orifice. A decrease in pressure drop over the orifice an inlet area of the diffuser orifice can be smaller as compared to cylindrical orifices having the same pressure drop. The maximum operating pressure difference between the inlet pressure and the outlet pressure is increased, because the inlet area of the orifice is smaller. The orifice 14 may also be an integral part of the membrane 12 with the same features for an orifice 14 provided in an orifice member 11.

Referring to FIGS. 1 and 2, the solenoid valve 1 furthermore comprises a support structure 17 connected to the membrane 12. The support structure 17 comprises three support members 18, 19, 20. Two of the support members 19, 20 are substantially ring disc shaped and enclose the membrane 12 at least partially from the topside or the bottomside of the membrane 12. The second support member 19 is provided in fluid contact with the servo chamber 13 and is connected to the orifice member 11. The orifice member 11 comprises a first annular flange 21 that rests against the second support member 19. The orifice member 11 also comprises a second annular flange 22 and the orifice member is connected to the third support member 20. The conical outlet section 14B may thus be formed together with the second annular flange 22.

The first support member 18 is connected to the membrane 12 at the radial outer end of the membrane 12. The first support member 18 fixes the membrane 12 to the housing 2. The first support member 18 furthermore comprises a plurality of openings 23 allowing the fluid from the inlet pressure chamber 7 to reach the membrane 12 in order to exert a pressure on the membrane.

If the solenoid valve 1 is in the open position, the membrane 12 may be displaced away from the valve seat by the pressure difference between the inlet chamber 7 and the servo chamber 13. Thereby a direct fluid connection from the inlet chamber 7 to the outlet chamber 8 is established. The support structure 17 provides a controlled movement of the membrane 12.

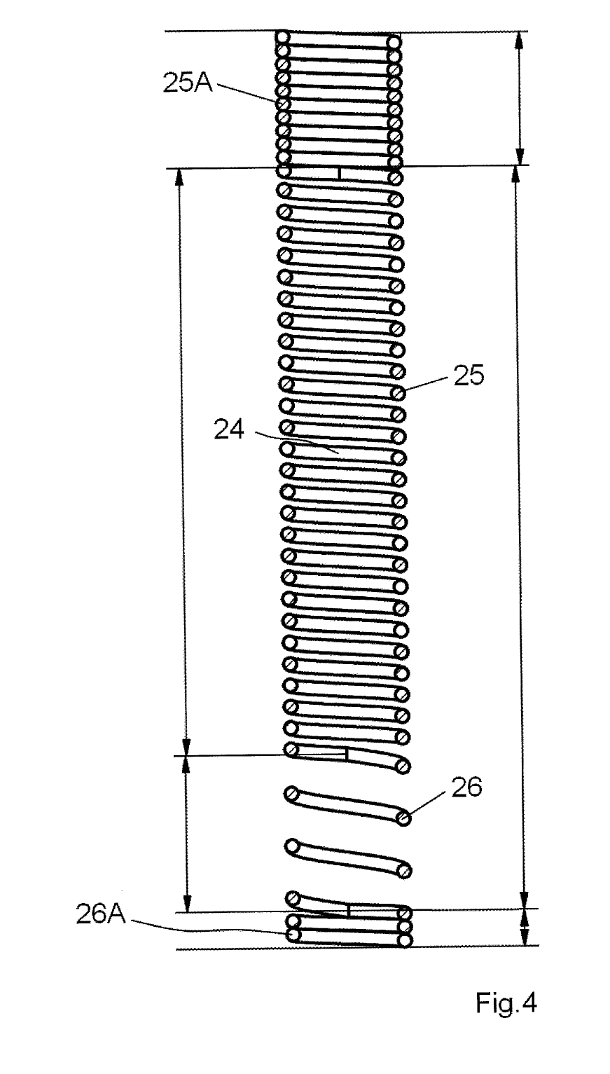

The solenoid valve 1 furthermore comprises a progressive spring 24. The progressive spring can be seen in more detail in FIG. 4. The progressive spring 24 comprises four spring sections 25, 25A, 26 and 26A. On both ends of the progressive spring 24 spring sections 25A, 26A with compressed windings are provided. The two spring sections 25A, 26A are stiff and stabilize the progressive spring and provides the spring forces being applied more evenly. The progressive spring 24 also comprises two spring sections 25, 26 that are compressible and have a different pitch. The spring section 25 has a lower pitch than the spring section 26. The spring constant of the progressive spring 24 will increase when the spring section 25 with a lower pitch has been fully compressed and only the spring section 26 with a larger pitch may still be compressed.

Referring to FIGS. 1 and 2, the progressive spring 24 is guided in a cylindrical bore 27. The cylindrical bore 27 comprises straight sidewalls 28 along most of the length of the cylindrical bore 27. Assembly of the solenoid valve 1 is simplified, because different kinds of progressive springs may be used with the same cylindrical bore 27.

The valve element 9 is slidably provided within an aperture 29, which may be in fluid connection to the cylindrical bore 27. The valve member 9 comprises three cylindrical sections with different radii.

The solenoid valve 1 furthermore comprises a valve member 30 being magnetizable. The valve member may be moved by providing an electric current to a coil (not shown) provided radially outside the valve member 30. The valve member 30 is slideably provided within a casing 31. The casing 31 is connected to the housing 2. The casing 31 furthermore defines an anchor 31A of the solenoid valve 1. The valve element 9, the progressive spring 24 and the valve member 30 are provided inside the anchor 31A. The valve member 30 has a substantially cylindrical shape, the radially outer circumference of the valve member is circular over most of the length of the valve member 30.

The cylindrical bore 27 and the aperture 29 are located inside the valve member 30 along the cylindrical axis of the valve member 30. The valve element 9, and the progressive spring 24 are guided within the valve member 30.

According to FIGS. 1 and 2 the solenoid valve 1 is shown in the normal position of the valve, the closed position. The valve element 9 sealingly abuts the valve seat 10, when the valve member 30 has been displaced by an additional stroke distance H1 beyond the valve element 9 (see FIG. 2). The stroke distance H1 is defined by the distance between an annular shoulder 32 of the valve element 9 and an annular ledge 33 of the valve member 30 in the closed position of the valve. The annular ledge 33 is part of a protrusion 34 located at the end of the aperture 29 towards the valve seat 10 in the opened position of the solenoid valve 1. The protrusion 34 extends from an inner circumference of the aperture 29. The annular ledge 33 provides a stop for the valve element 9.

When electric current is provided to the coil of the solenoid valve 1, a magnetic field will be present, displacing the valve member 30 in the direction away from the valve seat 10. The valve member 30 will initially be displaced independently from the valve element 9 until the valve member 30 has been displaced by the stroke distance H1. Along the stroke distance H1 the valve member 30 will be displaced by the magnetic field and gain momentum until the annular ledge 33 meets the annular shoulder 32 of the valve element 9 and displaces the valve element 9 from the valve seat 10. Because the valve member 30 has a long stroke distance H1, the valve element 30 can gain momentum to displace the valve element from the valve seat even if the pressure difference between inlet 5 and outlet 6 is large. The maximum operating pressure difference of the solenoid valve 1 is increased compared to the state of the art. The progressive spring 24 may have a low spring constant in the closed position of the solenoid valve 1.

The spring section 25 in the closed position of the solenoid valve 1 is not fully compressed and will only become stiff, fully compressed, after the valve element 9 has already been displaced from the valve seat 10. When the spring section 25 with the lower pitch is fully compressed, the spring constant of the progressive spring 24 is larger than in the closed position of the solenoid valve 1. Forces possibly preventing the valve member 30 from displacing towards the closing position can be overcome. Forces preventing the valve member 30 from displacing may for example be forces resulting from a residual magnetization of the valve member 30 when electric current to the coil of the solenoid valve 1 is not provided or adhesion forces holding the valve member 30 to the anchor 31A.

A relatively large spring force may be maintained in the open position of the solenoid valve 1 allowing closing the valve even if the operating pressure difference between the inlet 5 and the outlet 6 is large. At the same time, the spring force of the progressive spring 24 will be low in the closed position of the solenoid valve 1.

At the end of the casing 31 away from the valve seat 10, an anchor core 35 is positioned. The anchor core 35 is substantially cylindrical and is connected to the casing 31. At the end of the anchor core 35 towards the valve seat 10, an anchor protrusion 36 is positioned. The progressive spring 24 is abutting the anchor core 35 at the anchor protrusion 36 with the help of a bulge 37.

The cylindrical bore 27 comprises an additional end bore 38 positioned at the end of the valve member 30 away from the valve seat 10. In the open position of the solenoid valve 1, the valve member 30 may rest against the anchor protrusion 36 of the anchor core 35 at the widening 38 of the valve member 30. The additional end bore 38 comprises a tilted section 39 substantially matching the shape of the anchor protrusion 36.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1-15. (canceled)

16. A solenoid valve comprising a housing having an inlet and an outlet, wherein the solenoid valve further comprises a valve element and an orifice, wherein the orifice comprises an orifice inlet and an orifice outlet, and the orifice is provided in a membrane, and wherein the orifice has a diffuser characteristic in a direction from the orifice inlet to the orifice outlet, wherein the orifice comprises at least one conical orifice section, wherein the conical orifice section extends over most of length L of the orifice.

17. The solenoid valve according to claim 16, wherein walls of the conical orifice section are inclined relative to a central axis of the orifice by an angle of less than 10°.

18. The solenoid valve according to claim 16, wherein the cross-sectional area of the orifice inlet is smaller than the cross-sectional area of the orifice outlet.

19. The solenoid valve according to claim 16, wherein the walls of the conical orifice section are inclined relative to the central axis of the orifice by an angle of more than 2.5°.

20. The solenoid valve according to claim 16, wherein the orifice comprises at least one cylindrical orifice section.

21. The solenoid valve according to claim 16, wherein the orifice comprises at least one conical outlet section.

22. The solenoid valve according to claim 16, wherein the orifice is provided in an orifice member.

23. The solenoid valve according to claim 16, wherein the orifice is an integral part of a membrane.

24. The solenoid valve according to claim 16, wherein the solenoid valve comprises at least one progressive spring, wherein the valve element is loaded by the at least one progressive spring.

25. The solenoid valve according to claim 24, wherein the progressive spring comprises at least two spring sections, wherein at least two of the spring sections have a different pitch.

26. The solenoid valve according to claim 25, wherein the spring section with the lower pitch is fully compressed in the open position of the solenoid valve.

27. The solenoid valve according to claim 16, wherein the solenoid valve is a normally closed valve, wherein the valve element sealingly engages the valve seat, when the solenoid valve is not provided with an electrical current.

28. The solenoid valve according to claim 16, wherein the solenoid valve comprises a substantially cylindrical valve member that is received slideably within the solenoid valve.

29. The solenoid valve according to claim 16, wherein the solenoid valve further comprises an aperture, wherein the valve element is slidably received in the aperture.

30. The solenoid valve according to claim 29, wherein a protrusion extends from a radially inner circumference of the aperture, wherein the protrusion comprises an annular ledge at the end of the aperture facing the valve seat, and wherein the annular ledge provides a stop for the valve element.

31. A vapor compression system, comprising the solenoid valve according to claim 16.

32. The solenoid valve according to claim 17, wherein the walls of the conical orifice section are inclined relative to the central axis of the orifice by an angle of more than 2.5°.

33. The solenoid valve according to claim 17, wherein the orifice comprises at least one cylindrical orifice section.

34. The solenoid valve according to claim 18, wherein the orifice comprises at least one cylindrical orifice section.

35. The solenoid valve according to claim 17, wherein the orifice comprises at least one conical outlet section.
